(19) United States
(12) Patent Application Publication
(10) Pub. No.: US 2026/0070278 A1
(43) Pub. Date: Mar. 12, 2026

(54) EXTRUSION PERFORATION SYSTEM AND METHOD

(71) Applicant: Bixby International Corporation, Newburyport, MA (US)

(72) Inventors: Ethel Bermejo, Somerville, MA (US); Marc Gagnon, Amesbury, MA (US); Chris Van Remoortel, Marblehead, MA (US); Robert Law, Haverhill, MA (US); Rachel Lucier, Lynn, MA (US); Aaron Arsenault, Leominster, MA (US)

(73) Assignee: Bixby International Corporation, Newburyport, MA (US)

(21) Appl. No.: 19/391,806

(22) Filed: Nov. 17, 2025

Related U.S. Application Data
(63) Continuation of application No. 18/249,965, now Pat. No. 12,496,764.
(60) Provisional application No. 63/104,918, filed on Oct. 23, 2020.

(51) Int. Cl. B29C 59/04; B29C 48/00

(52) U.S. Cl. CPC B29C 59/04; B29C 48/0011; B29C 48/002

(57) ABSTRACT

An extrusion system includes a system to pump a thermoplastic resin melt through an extrusion die, the thermoplastic resin including a polymer base whose rheological properties are modified using fillers, a perforation/embossed roll, and a resilient/pressure backing nip roll through which the extruded thermoplastic resin melt travels between the perforation/embossed roll and the resilient/pressure backing nip roll in a roll nip/station area, exiting the roll nip/station area and around the resilient/pressure backing nip roll and subsequently released from the resilient/pressure backing nip roll as a perforated film, film or fabric carrier supported perforated film, coex laminate, or cut into sheet

### CROSS REFERENCE TO RELATED APPLICATIONS

This application claims benefit from U.S. Provisional Patent Application Ser. No. 63/104,918, filed Oct. 23, 2020, which is incorporated by reference in its entirety.

### BACKGROUND OF THE INVENTION

The present invention relates generally to extrusion, and more particularly to an extrusion perforation system and method.

In general, the manufacturing of perforated extruded thermoplastic films, sheets, or laminates usually requires multiple steps. In most two-step processes, a film or sheet must be extruded into either one or several large master rolls for subsequent processing. The extruded web can also be cut and stacked as sheeted product for downstream processing. These extruded rolls or sheet are then perforated through one or more secondary processing operations.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features an extrusion system including a system to pump a thermoplastic resin melt through an extrusion die, the thermoplastic resin including a polymer base whose rheological properties are modified using fillers, a perforation/embossed roll, and a resilient/pressure backing nip roll through which the extruded thermoplastic resin melt travels between the perforation/embossed roll and the resilient/pressure backing nip roll in a roll nip/station area, exiting the roll nip/station area and around the resilient/pressure backing nip roll and subsequently released from the resilient/pressure backing nip roll as a perforated film, film or fabric carrier supported perforated film, coex laminate, or cut into sheet.

In another aspect, the invention features a system including a thermoplastic extrusion die, a perforation/embossed roll, and a resilient/pressure backing nip roll, wherein an extruded polymer melt from the die travels between the perforation/embossed roll and the resilient/pressure backing nip roll in a roll nip/station area.

In still another aspect, the invention features a method including producing a continuous polymer melt web from a cast extruder, forcing the continuous polymer melt web through a flat sheet die from which it exits at a desired width and thickness, nipping the continuous polymer melt web between a first roll and a second roll that are temperature controlled through internal circulation of a heat transfer medium.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram of an exemplary extrusion system.

FIG. 2 is a block diagram of the roll nip/station area.

FIG. 3 illustrates an exemplary design of the perforating metal roll.

FIG. 4 illustrates an exemplary design of the perforating roll with the pins.

FIG. 5 illustrates a table.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

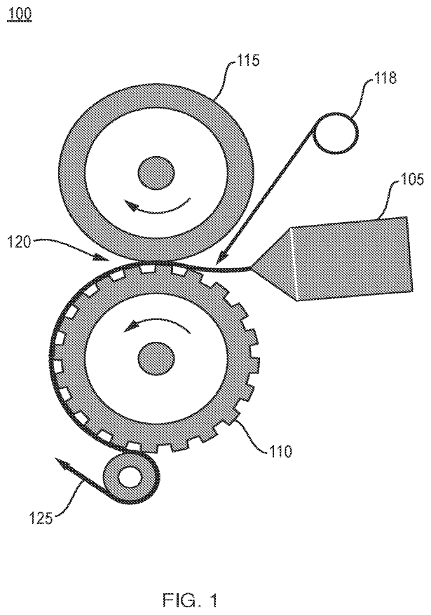

As shown in FIG. 1, a portion of an exemplary extrusion system 100 includes an extrusion die 105, a perforation/embossed roll 110, a resilient/pressure backing nip roll 115 and PET, film interleaf or fabric unwind 118. The extrusion die travels between the perforation/embossed roll 110 and the resilient/pressure backing nip roll 115 in a roll nip/station area 120. The extrusion die 105 exits a roll nip/station area 120 and around the resilient/pressure backing nip roll 115 as a stretch TPE perforated film with PET carrier 125.

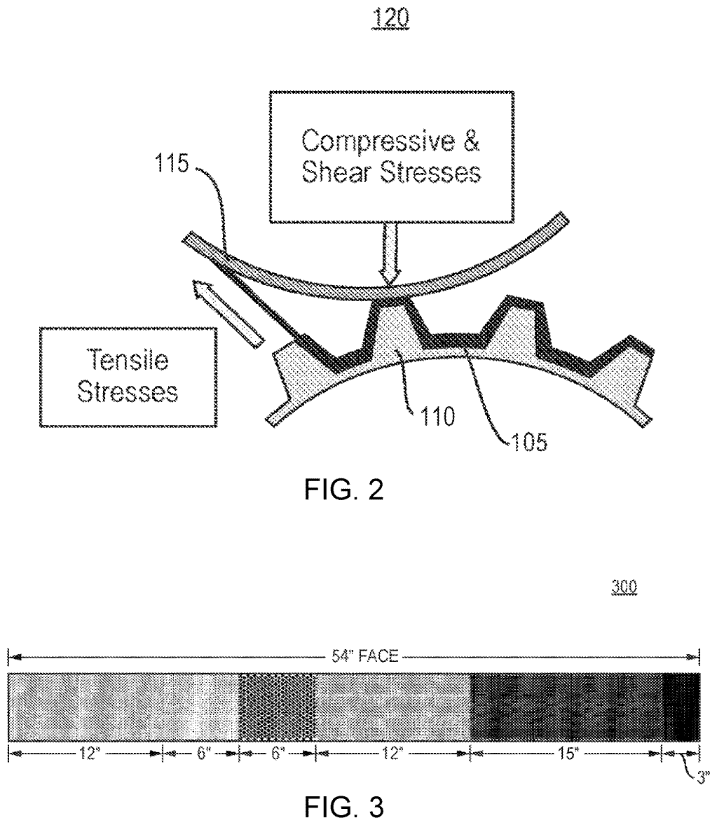

In FIG. 2 the roll nip/station area 120 is shown in greater detail. More particularly, the extrusion die 105 has compressive and shear forces applied to it by the resilient/pressure backing nip roll 115 and tensile stresses applied by the perforation/embossed roll 110.

In summary, the exemplary extrusion system enables in-situ and continuous perforation of either rigid or elastic thermoplastic materials during the extrusion process (i.e., perforation does not require a secondary separate operation) and without the need for vacuum or other assists. In addition, the single-step process reduces waste significantly.

The cast extruder 100 is used to produce a continuous polymer melt web. The homogeneous melt is forced to flow through a flat sheet die from which it exits at the desired width and thickness. The polymer melt exiting the die is nipped between two rolls 110, 115 that are temperature controlled through internal circulation of an appropriate heat transfer medium such as hot water or oil or a mix of the two.

The patterned chill roll 110 is a metal roll such as steel core roller or equivalent whose surface has been engraved to contain three-dimensional designs such as pins (and, if desired, embossing patterns). These engraved pins create the desired through-holes and relief patterns in the molten web, in-situ, during extrusion. The specific three-dimensional geometries, patterns, and sizes of the pins and embossing features can be etched using various known techniques such as chemical, laser, or mechanical etching. The steel roller 110 is usually coated with a chrome plating or equivalent to increase durability of the roll.

The molten polymer web coming from the extruder head is deposited onto the surface of the metal roll 110 and the web then conforms to the etched features on the surface.

The second roll 115 is a hard durometer rubber roll preferably encased in Polytetrafluoroethylene (PTFE) shrink-wrap or similar fluoropolymer film to enhance roll durability, durometer, and release of cooled polymer film and “chads.”. The purpose of this roll 115 is to “pull off” the perforated extruded film from the metal roll 110 and to provide the compression forces of the film against the engraved roll in the nip. The compressive forces of the rubber roll 115 acting upon the polymer web that is deposited on the engraved roll 110 create certain areas with stress concentrators, mostly at the top of the pins of the metal roll 110. The subsequent action of the puller roll 115 stretching the cooled film in the machine direction helps these stress concentrators to create micro-cracks that propagate as they are under a stretch force. The stretching force pulls and separates the “chads” or fragmented holes from the main film. These “chads” stay on the rubber roll 115 and can be collected through vacuum assistance, a sticky driven idler, or by other means and eventually be recycled.

One key to the in-situ extrusion perforation process described above is designing and controlling the specific mechanical geometry, rheological and thermal properties, and their close relationships, necessary to create the proper stresses on the dynamic polymer web through the perforating process step.

First, the polymer's rheological properties, which can be modified using fillers or additives in the polymer chosen for this process, are critical to success. The polymer base resins can include thermoplastic elastomers such as polyurethanes, styrene-block-copolymers, polyether block amides, polyester adhesives, nylon adhesives, functionalized olefins, or copolyesters. They can also include higher durometer and rigid polymers like copolyesters, styrenics, polycarbonates, or nylons. The inorganic or organic fillers include nano calcium carbonate, calcium carbonate, titanium dioxide, talc, carbon black, and so forth. The fillers are selected to manage the rheological properties of the base polymer at process temperatures to ensure proper perforation without causing a dramatic change on the intrinsic properties of the polymer matrix itself when solidified.

Second, the geometric design of the patterned engraved roll 110 surface is also important to ensure effective perforation. The diameter of the pins are equivalent to the size of the perforated hole desired. The spacing or distance between the pins, the depth of the engraved roll 110, and ratio of these two variables need are strategically defined to ensure a successful perforating process based on the selected polymer formulation. The pin and detail design of the engraved pattern must also consider specific radii and draft angles to facilitate the creation of stress concentrations while the molten polymer goes from a low melt elongation/melt strength state through to a higher melt elongation and ultimately to a solid, formed web. The combination of properly designed and located stress concentrations in the roll emboss geometry, with a tailored melt rheology enables the melt web to tear in a controlled manner as the web cools, shrinks and forms into a solid film or sheet 125. The ratio of the depth, size and spacing of design geometries and pins also controls the degree of web stretching through the roll nip during rapid cooling, shrink, and pulling from the roll.

Proper design of these mechanical details ensures the appropriate stress is applied to the dynamically cooling formulated polymer web. In this manner, the roll and polymer variables create the mechanical and rheological conditions such that perforations can occur in the web simultaneously through the nip. Finally, the specific extrusion temperatures, gauge and output is set to deliver the molten web with the proper rheology as described to be perforated through the nip and subsequently cooled in place on the etched texture roll 110. Sufficient cooling capacity must be available to closely control the temperature of the roll 110 and hence further manage the rheology of the polymer as it enters, passes through, and exits the nip section between the rubber and embossing roll.

Because the molten polymer web 105 is quench cooled upon contacting the metal pins and emboss detail of the cooling roll 115 while the interstices between these design details remain hot and molten, both thermal shrinkage and mechanical stresses act at the designed stress concentrations on pins and geometric patterns. The combination of those stresses and design geometries creates controlled cracks in the web that propagate, tearing along pin and patterned edges. The edges are stress concentrators that separate quenched solidifying polymer from ‘elastic’ molten polymer in the designed pattern's valleys. With the edges sheared by compressive forces developed as the web is driven into the rubber backing roll, the polymer still cooling in the valleys is stretched, pulled under tension from the metal roll, completing the perforation around the pins and design.

The perforated (and embossed if desired) polymer web 125 is now solidified into a plastic web that can now be wound onto a core to create a continuous roll of perforated film or sheet. If the rolled film or sheet material has a propensity to block, or stick together, a liner or separator film can be introduced downstream or at the nip extrusion/station area to facilitate downstream use or unwinding of the film to prevent sticking or blocking of the perforated roll. An unwind roll located before the extrusion die contains the thin PET liner (0.001″-0.005″ thick) to be used as a supporting film that improves handling of the extruded film in downstream equipment processes like slitting, die-cutting, and winding. The PET liner is passed through an idler and tensioning roll to remove wrinkles and flatten the web before it is introduced above the extrusion die directly into the extrusion nip-area between the perforated/embossed roll and the resilient/pressure backing nip roll Similarly, another material could be introduced here in place of a PET or other carrier liner. For instance, introducing a four-way stretch material like a knit or an elastic fabric, like Lycra® or Spandex®, allows improved web handling of the perforated elastic core material while also laminating to a fabric in one step. For many applications, this eliminates the need for further downstream processing to make a laminate.

In FIG. 3, an example of a design of the perforating metal roll 300 is illustrated. The patterned metal roll 300 includes strategically spaced pins and geometrical features that enhance the aesthetics and the properties of the perforated film. The patterned metal roll 300 can have one or multiple designs with varying pin diameter (>0.5 mm) and spacing (>0.5 mm) and with embossed figures on some of them such as hearts, honeycomb, flowers, and so forth.

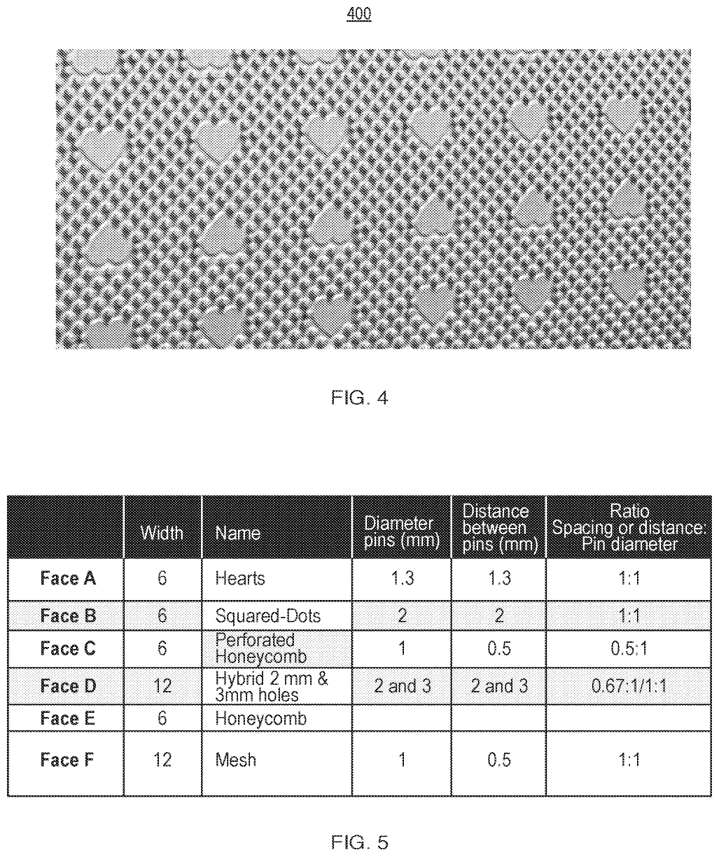

In FIG. 4, an example of a design 400 of the perforating roll with the pins (diameter 1.3 mm) and embossed hearts is illustrated.

In FIG. 5, TABLE 1 illustrates exemplary design features on an engraved roll to ensure effective perforation. Here, a depth of the engraved roll is 0.040″.

Perforation of plastic films provides important performance features-for example, they can make apparel more breathable and comfortable. In the apparel and textile industries, elastic stretch or rigid adhesive films are replacing traditional sewn seams, reinforcement tapes or compression garments. These films include materials such as polyurethanes, styrene-block-copolymers, polyether block amides, polyester adhesives, nylon adhesives, and silicones. They are used in garments for better control of stretch force, increased elasticity and recovery, and enhanced control of pressure in certain areas of the body. However, the intrinsic nature of the polymer chains and their morphology make these films poor carriers of body moisture and heat which could result in discomfort (e.g., a moist and hot film/fabric could continuously rub the skin to the point of blisters). A common solution is to perforate the films via a secondary conversion step.

There are several commercial applications and end use cases where perforations create additional film functionality—for example, perforations can (1) provide liquid or gas permeability in garments; (2) allow vacuum to be pulled through for use in industrial applications such as vacuum cutting belts; (3) allow the release of air that can be trapped at the interface of laminated substrates or sheets during multi-layer constructions; (4) create unique aesthetics via perforated patterns and embossing effects in monolayer and laminate products; (5) manage heat transfer and cooling at the interface between two substrates or surfaces (e.g., air-cooled automotive seating). In all these cases the one-step process above brings major advantages in cost, quality, and efficiency.

The one-step process of the present invention greatly simplifies the extrusion of rigid and elastic perforated thermoplastic film and sheet by accomplishing the extrusion, perforation and embossing in a single step. This is more cost-effective by eliminating the need for secondary processing and the associated steps and expense of interim work-in-process (WIP) goods (rolls or sheets) which need to be conveyed or transferred to separate perforating equipment (e.g. hot-pin or cutting rolls—sometimes at different locations/facilities). Additional handling is further avoided if the final product includes an embossed design which may require registering the perforations for proper alignment of the embossing.

The present invention enables the manufacture of unique, innovative and cost-advantaged products for several markets—notably apparel and textile, durable decorative laminates, and belting.

The present invention is of value for elastic products where perforation and embossing can enhance the design, texture and functionality of the products to create customized and unique product branding or end use.

Potential applications include, for example:

(1) Fashion textiles, no sew assembly and elastics in apparel and textiles:

Formable, bondable (no sew), breathable, decorative embossed and/or perforated thermoplastic elastics and textiles. Apparel products and components to replace latex, silicone, natural rubber elastic products that can't be formed or bonded. Elastic apparel without latex allergy or silicone sensitivity. Would be used by intimate apparel, underwear, sportswear, textile, footwear companies in functional and fashion products. Used as elastics in all types of clothing and footwear fashions and brands. Elastic products can be applied without sewing acting as a fastening system to replace sewn seams while also acting as an elastic for fit and movement enhancement in clothes design.

(2) Industrial coated fabrics and belts that require breathability or ability to draw vacuum through fabric/belt to hold items in place on belts/surfaces or to remove liquids from products on belts or surfaces, e.g., cutting belts that hold sheet goods in place for die cutting; paper machine clothing belts that are used to draw water from pulp emulsions, conveyor belts that use vacuum to handle items being carried, drying belts that allow passage of water and heat from beneath the product to be dried, and so forth.

(3) Various film and sheet products that are attached to smooth surfaces for decoration, protection & durability, or haptic (grip or elastic/spongy tactile feel & design); perforation allows release of trapped air bubbles from between surface interface:
a. Decals
b. Logos
c. Screen & Paint protection films
d. Soft touch grip films

It would be appreciated by those skilled in the art that various changes and modifications can be made to the illustrated embodiments without departing from the spirit of the present invention. All such modifications and changes are intended to be within the scope of the present invention except as limited by the scope of the appended claims.

1-22. (canceled)

23. An article comprising:
a monolithic thermoplastic film or sheet having opposed first and second major surfaces;
a plurality of through-holes extending from the first major surface to the second major surface and arranged in a repeated pattern; and
embossed three-dimensional relief features on at least the first major surface between the through-holes, the relief features being registered with the repeated pattern of the through-holes such that the relief features maintain a fixed spatial correspondence to corresponding through-hole pattern elements; and
wherein each through-hole has a diameter greater than 0.25 mm and adjacent through-holes in the pattern are separated by a spacing greater than 0.25 mm.

24. The article of claim 23, wherein the embossed three-dimensional relief features define aesthetic figures in a field or an area between the through-holes.

25. The article of claim 23, wherein the embossed three-dimensional relief features define aesthetic figures in a field or an area between the through-holes, and wherein the aesthetic figures comprise hearts, honeycomb, flowers, and/or custom geometries.

26. The article of claim 23, wherein the film or sheet is elastic or rigid and comprises a polymer selected from polyurethanes, styrene-block-copolymers, polyether block amides, polyester adhesives, nylon adhesives, functionalized olefins, copolyesters, styrenics, polycarbonates, and nylons.

27. The article of claim 23, further comprising a polyethylene terephthalate (PET) liner disposed against the second major surface, the PET liner having a thickness of 0.001″-0.005″ (0.0254 mm -0.127 mm).

28. The article of claim 23, wherein each through-hole has a diameter greater than 0.5 mm and adjacent through-holes are separated by a spacing greater than 0.5 mm.

29. An article comprising:
a fabric layer; and
a thermoplastic layer bonded to one side of the fabric layer, the thermoplastic layer having opposed first and second major surfaces, the first major surface being away from the fabric layer;
the thermoplastic layer including a plurality of through-holes extending from the first major surface through the thickness of the thermoplastic layer;
wherein the through-holes do not extend through the fabric layer, and
wherein the first major surface of the thermoplastic layer further includes embossed three-dimensional relief features in areas between the through-holes.

30. The article of claim 29, wherein each through-hole has a diameter greater than 0.25 mm and adjacent through-holes are separated by a spacing greater than 0.25 mm.

31. The article of claim 29, wherein the embossed three-dimensional relief features are registered with a pattern of the through-holes such that the relief features maintain a fixed spatial correspondence to corresponding through-hole pattern elements.

32. The article of claim 29, wherein the embossed three-dimensional relief features define aesthetic figures in a field or an area between the through-holes.

33. The article of claim 29, wherein the thermoplastic layer comprises a polymer selected from polyurethanes, styrene-block-copolymers, polyether block amides, polyester adhesives, nylon adhesives, functionalized olefins, copolyesters, styrenics, polycarbonates, and nylons, optionally containing fillers.

34. The article of claim 29, wherein an arrangement of the through-holes is configured to provide a vacuum permeability through the article to permit vacuum to be drawn through the article for vacuum-handling applications including vacuum cutting belts.

35. A method comprising the steps of:
(A) pumping a thermoplastic resin melt to an extrusion die, the thermoplastic resin comprising a polymer base whose rheological properties are modified using fillers;
(B) introducing a moving fabric or film to one side of the thermoplastic resin melt as the melt exits the extrusion die;
(C) nipping the melt together with the fabric or film between (i) a patterned perforation/emboss roll and (ii) an opposite-rolling resilient/pressure backing nip roll, the perforation/emboss roll and the resilient/pressure backing nip roll being temperature-controlled by internal circulation of a heat-transfer medium, the resilient/pressure backing nip roll being a hard-durometer rubber roll encased in polytetrafluoroethylene (PTFE) shrink-wrap or a fluoropolymer film, and the perforation/emboss roll comprising strategically spaced pins having pin diameters greater than 0.5 mm and pin spacings greater than 0.5 mm;
(D) within the nip, first quench-cooling the fabric or film and the thermoplastic resin melt; then simultaneously perforating and embossing only the thermoplastic resin melt; and then releasing the melt and the fabric or film from the nip, whereby through-holes extend through the thermoplastic layer and do not extend through the fabric when present;
(E) recovering (i) a fully-perforated thermoplastic web supported by a carrier film, or (ii) an extruded perforated polymer-web/fabric laminate, and winding into a continuous roll or sheeting by cutting.

36. The method of claim 35, wherein the heat-transfer medium includes hot water or oil.

37. The method of claim 35, wherein the perforation/emboss roll is a metal roll whose surface has been engraved to contain three-dimensional designs that create through-holes and relief patterns in the polymer melt web.

38. The method of claim 35, wherein recovering comprises sheeting by cutting the recovered web into sheets.

39. The method of claim 35, further comprising introducing a PET liner having a thickness of 0.001″-0.005″ (0.0254 mm-0.127 mm) upstream of the die to support downstream handling.

40. The method of claim 35, wherein the pins have a diameter of about 13 mm in at least one region of the patterned roll.

41. The method of claim 35, further comprising collecting chads from the backing roll via vacuum assistance or a sticky driven idler.

42. The method of claim 35, wherein an embossed relief between the through-holes defines aesthetic figures, including hearts, honeycomb, flowers, and/or custom geometries.
